(19) United States
(12) Patent Application Publication
(10) Pub. No.: US 2024/0419741 A1
(43) Pub. Date: Dec. 19, 2024

(54) DOCUMENT MANAGEMENT SYSTEM, DOCUMENT MANAGEMENT SERVER, AND DOCUMENT MANAGEMENT METHOD FOR AUTOMATICALLY PRESENTING MODIFIED PART OF RELATED DOCUMENT DATA

(71) Applicant: KYOCERA Document Solutions Inc., Osaka (JP)

(72) Inventor: Hidenori SHOJI, Concord, CA (US)

(73) Assignee: KYOCERA Document Solutions Inc., Osaka (JP)

(21) Appl. No.: 18/335,128

(22) Filed: Jun. 14, 2023

(51) Int. Cl. G06F 16/93; G06F 16/332

(52) U.S. Cl. CPC G06F 16/93; G06F 16/3329

(57) ABSTRACT

Provided is a document management system that automatically presents a modified part of related document data. The modified document acquiring unit acquires modified document data that has been modified. The related document acquiring unit selects and acquires related document data for the modified document data acquired by the modified document acquiring unit from a plurality of document data. The question generating unit generates a question sentence from a sentence of the modified part of the modified document data acquired by the modified document acquiring unit. The modification deciding unit generates answers to the question sentence generated by the question generating unit for the modified document data and the related document data, respectively, and, when the similarity between the answers is lower than a specific threshold, determines that the related document data needs to be modified and presents the determination to the user.

### BACKGROUND

The present disclosure relates particularly to a document management system, a document management server, and a document management method for storing plurality of document data.

Typically, there exist an image forming an apparatus such as an MFP (Multi-Functional Peripheral) that can print documents and images. There is also a document management system that manages a plurality of document data in conjunction with the image forming apparatus.

As a typical technology, a document service system is disclosed that, when a screen display is specified by specifying a document element of interest, finds a document element related to that element from a related table and calculates similarity between the document element of interest and each related document element. In this technology, the system calculates the difference between the calculated similarity and the previous similarity recorded in the related table for each related document element, and it generates and provides to a user a screen with information on each related document element arranged, for example, in order of the extent of the decrease in similarity indicated by the difference in descending order.

In this technology, when a document element is changed, information of another document element related to the document element can be displayed according to the change between those two document elements caused by the change. In other words, it detects changes in the attention sentence set by the user and prompts the user to modify it.

### SUMMARY

A document management system according to the present disclosure is a document management system having a document management server storing a plurality of document data, including: a modified document acquiring unit that acquires modified document data that has been modified; a related document acquiring unit that selects and acquires related document data for the modified document data acquired by the modified document acquiring unit from the plurality of document data; a question generating unit that generates a question sentence from a sentence of a modified part in the modified document data acquired by the modified document acquiring unit; and a modification deciding unit that respectively generates answers to the question sentence generated by the question generating unit for the modified document data and the related document data and, when the similarity between the answers is lower than a specific threshold, determine that the related document data needs to be modified and presents determination to the user.

A document management server according to the present disclosure is a document management server storing a plurality of document data, including: a modified document acquiring unit that acquires modified document data that has been modified; a related document acquiring unit that selects and acquires related document data for the modified document data acquired by the modified document acquiring unit from the plurality of document data; a question generating unit that generates a question sentence from a sentence of a modified part in the modified document data acquired by the modified document acquiring unit; and a modification deciding unit that respectively generates answers to the question sentence generated by the question generating unit for the modified document data and the related document data and, when the similarity between the answers is lower than a specific threshold, determine that the related document data needs to be modified and presents determination to the user.

A document management method according to the present disclosure is a document management method executed by a document management system having a document management server storing a plurality of document data, including the steps of: acquiring modified document data that has been modified; and acquiring related document data for the modified document data that has been acquired by selecting from the plurality of document data; and generating a question sentence from a sentence of a modified part in the acquired modified document data; and generating answers to the generated question sentences for the modified document data and the related document data, respectively; and determining that, when the similarity between the answers is lower than a specific threshold, the related document data needs to be modified; and presenting determination to the user.

### BRIEF DESCRIPTION OF THE DRAWINGS

FIG. 1 is a system configuration figure of an image forming system according to an embodiment of the present disclosure;

FIG. 2 is a block diagram showing a control configuration of the server as shown in FIG. 1;

FIG. 3 is a block diagram showing a functional configuration of the server according to the embodiment of the present disclosure;

FIG. 4 is a flowchart of a related document modification and presentation process according to the embodiment of the present disclosure;

FIG. 5 is a screen example of modification in the related document modification and presentation process as shown in FIG. 4;

FIG. 6 is a screen example of modification in the related document modification and presentation process as shown in FIG. 4; and

FIG. 7 is a system configuration figure of an image forming system according to other embodiment of the present disclosure.

### DETAILED DESCRIPTION

### [System Configuration of Image Forming System X]

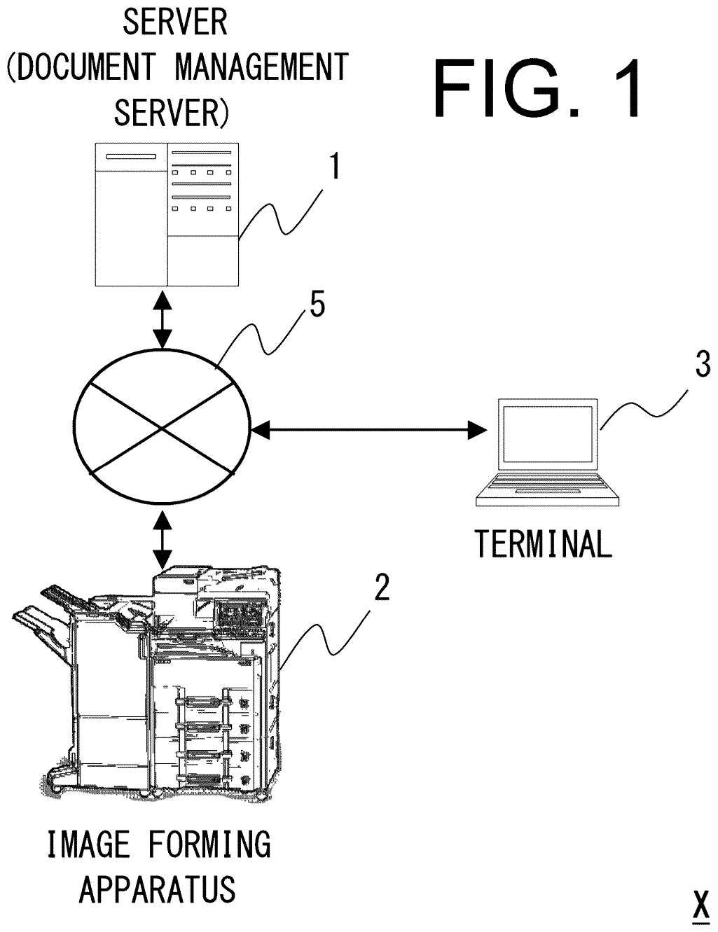

Firstly, with reference to FIG. 1, a system configuration of an image forming system X is described. The image forming system X is an example of a document management system. The image forming system X uses AI (Artificial Intelligence) for natural language processing, such as summarization and similarity analysis, or the like, and presents a related document and its modified part according to the modified part in the document data.

The image forming system X has a server 1, an image forming apparatus 2, and a terminal 3, and each apparatus is connected with a network 5.

The server 1 is an example of a document management server according to the present embodiment that stores and manages document data. The server 1 may be, for example, a server for pull-printing that controls the image forming apparatus 2, a server that is for DMS (Document Management System), a server that processes documents, or the like. Specifically, server 1 may be a PC (Personal Computer) server, a dedicated machine, a general-purpose machine, a PC with a dedicated application installed for the image forming apparatus 2, a smartphone, a NAS (Network-Attached Storage), a high-performance image forming apparatus, or the like.

The image forming apparatus 2 is an example of an apparatus that outputs or reads document data. In particular, the image forming apparatus 2 is an MFP, network scanner, document scanner, network fax machine, a printer with scanner function, or the like. The image forming apparatus 2 may execute an application software (hereinafter simply referred to as “application”) for connecting to the server 1.

In the present embodiment, the image forming apparatus 2 may be provided with a function to read (scan) a set of documents and an image forming function to print or convert documents into electronic documents. In addition, the image forming apparatus 2 may be connected with the server 1 by USB (Universal Serial Bus), or the like.

The terminal 3 is the terminal of the user who modified the document. Specifically, the terminal 3 may be a PC, a smartphone, a cellular phone, a tablet terminal, a dedicated terminal, a PDA (Personal Digital Assistant), or the like.

In the present embodiment, the terminal 3 can install and execute various applications such as a web browser for accessing server 1, a device driver for the image forming system X, dedicated applications for document management and document modification, and the like. This allows the user using terminal 3 to access server 1 and upload, manage, and modify documents via the UI (User Interface).

The network 5 is, for example, a LAN (Local Area Network), wireless LAN, WAN (Wide Area Network), cellular phone network, voice phone network, or the like.

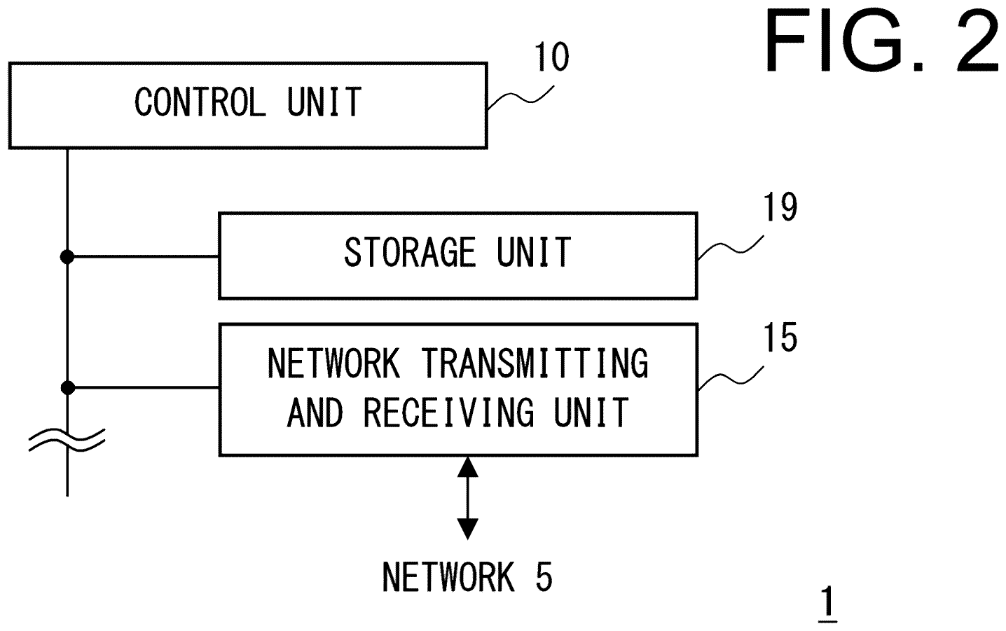

Next, with referring to in FIG. 2, a control configuration of the server 1 is described.

The server 1 includes a control unit 10, a network transmitting and receiving unit 15, and a storage unit 19.

The control unit 10 information processing unit such as a CPU (Central Processing Unit), MPU (Micro Processing Unit), GPU (Graphics Processing Unit), TPU (Tensor Processing Unit), DSP (Digital Signal Processor), ASIC (Application Specific Integrated Circuit), or the like.

The control unit 10 is made to operate as each of the functional blocks as described later by reading a control program stored in the ROM or HDD of the storage unit 19, expanding the control program into RAM, and executing it. The control unit 10 also controls the entire apparatus in response to instruction information input from the terminal 3 or the operation panel unit of the image forming apparatus 2.

In the present embodiment, the control unit 10 may also have the function of an AI accelerator to perform the analysis process. Specifically, the control unit 10 may, for example, provide the accelerator of sum-of-products operations for a neural network for so-called deep learning by using a GPU, TPU, or the like. Thus, the control unit 10 may use learned models or train models. In the present embodiment, it is possible to use natural language processing models for processing human-understandable data of a natural language, various models related to image processing including OCR (Optical Character Recognition), and the like. Among these, in the natural language processing, models such as GAN (Generative Adversarial Network), transformer, or the like, which are described later, can be used. In the natural language processing, models such as GAN, transformer, or the like, can be used. Also, for OCR, it is possible to perform character recognition by using a convolutional neural network, or the like, to obtain characters and character positions on the image data, and to perform keyword extraction.

Furthermore, the control unit 10 can convert the data of the document before and after modification into an electronic document such as PDF or an image data file such as TIFF, or the like.

The network transmitting and receiving unit 15 is a network connection unit that includes a LAN board or a wireless transmitting and receiving unit for connecting to the network 5.

The network transmitting and receiving unit 15 transmits and receives data on data communication lines and voice signals on voice telephone lines.

The storage unit 19 is a storage part having a non-transitory recording medium. The storage unit 19 includes semiconductor memory such as ROM (Read Only Memory) and RAM (Random Access Memory), magnetic storage medium such as HDD (Hard Disk Drive), or the like.

The ROM and HDD of storage unit 19 store a control program for controlling the operation of the server 1. The control program includes an OS (Operating System) and an application. In addition to this, the storage unit 19 also stores a database, various model data, user account settings, or the like. The storage 19 may also store a document box (a storage folder, a shared folder) for each user, information about performance and functions, or the like.

In addition, in the server 1, the control unit 10 may be integrally formed, such as a CPU with a built-in GPU, a chip-on-module package, a SOC (System On a Chip), or the like.

The control unit 10 may also have built-in RAM, ROM, flash memory, or the like.

### [Functional Configuration of Server 1]

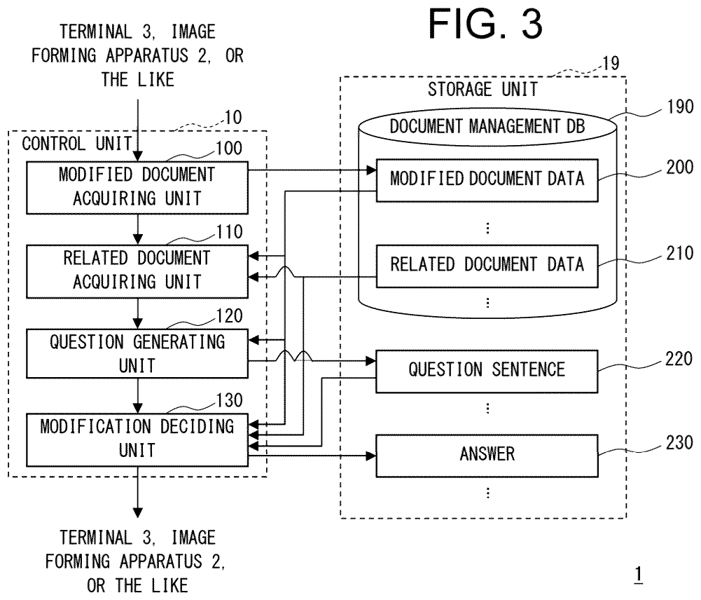

Here, as refer to FIG. 3, a functional configuration of the server 1 is described.

The control unit 10 of server 1 has a modified document acquiring unit 100, a related document acquiring unit 110, a question generating unit 120, and a modification deciding unit 130.

The storage unit 19 stores document management DB 190, a question sentence 220, and an answer 230.

The modified document acquiring unit 100 acquires the modified document data 200. The modified document acquiring unit 100 can acquire the data from the user's terminal 3 or from the image forming apparatus 2, or the like.

The related document acquiring unit 110 selects and acquires related document data 210 for the modified document data 200 acquired by the modified document acquiring unit 100 from a plurality of document data.

In the present embodiment, the related document acquiring unit 110 may select the related document data 210 based on the similarity of the text with the modified document data 200. Also, the related document acquiring unit 110 may select the related document data 210 based on the similarity of the document attributes with the modified document data 200. This similarity of document attributes includes the similarity of the creator, editor, creation time, change time, and viewer. Furthermore, the related document acquiring unit 110 may select the related document data 210 based on both the similarity of the text and the similarity of the document attributes.

Additionally, the related document acquiring unit 110 may determine the similarity of the text and/or the similarity of the document attributes by a classification model of clustering and/or machine learning (AI). Specifically, the related document acquiring unit 110 can perform clustering by applying, for example, similarity such as appearance frequency of text characters and words, or the like, to a general method such as the UPGMA (Unweighted Pair Group Method with Arithmetic mean) method, the k-means method, or the self-organizing map method as the classification model. Also, the AI classification model can be similarly output the similarity between the documents based on the similarity of the frequency of occurrence of characters and words, or the like.

The question generating unit 120 generates the question sentence 220 from a sentence of a modified part in the modified document data 200 acquired by the modified document acquiring unit 100.

In the present embodiment, the question generating unit 120 can generate natural language question sentences by using a natural language processing model for generating various types of questions (hereinafter referred to as “question generation model”). Specifically, for example, the question generating unit 120 can generate a question by GAN.

Further, the question generating unit 120 can present the question sentence 220 to the user for confirmation.

The modification deciding unit 130 generates the answers 230 to the question sentence 220 generated by the question generating unit 120 for the modified document data 200 and the related document data 210, respectively.

The modification deciding unit 130 can generate the answer 230 by using a natural language processing model to generate an answer in response to the question sentence 220 (hereinafter referred to as “question answering model”). Specifically, for example, the modification deciding unit 130 may generate character string data of answers 230 to the question in natural language by a question answering model of transformer such as BERT, or the like.

Further, the modification deciding unit 130 then calculates the similarity between the answer 230 to the modified document data 200 and the answer 230 to the related document data 210. If the similarity between these answers 230 is lower than a specific threshold, the modification deciding unit 130 determines that the related document data 210 needs to be modified. The modification deciding unit 130 presents this determination to the user. In particular, the modification deciding unit 130 presents the related document data 210, which the modification is determined to be necessary, and the part, which the modification is necessary, to the user.

Here, the classification model of the related document acquiring unit 110, the question generation model of the question generating unit 120, and the question answering model of the modification deciding unit 130 may have been trained to a specific degree by using each document data, or the like, in the document management DB 190. Further, the accuracy can then be improved by obtaining feedback from user modifications.

In addition, when GAN is used for the question generation model, the question answering model may be trained simultaneously as a discriminator.

The document management DB 190 is a database in which each document data managed by the document management system X is stored.

In the present embodiment, the document management DB 190 stores a plurality of document data. This plurality of document data includes the modified document data 200 and the related document data 210.

The modified document data 200 and the related document data 210 may be files of applications such as word processors, spreadsheets, presentations, or the like, or electronic document data such as PDF (Portable Document Format), or the like. Alternatively, the modified document data 200 and the related document data 210 may be image data such as BMP (bitmap data), TIFF, JPG, or the like. The modified document data 200 and the related document data 210 may be created by the user at the terminal 3 or generated by scanning, or the like, at the image forming apparatus 2. If the modified document data 200 and the related document data 210 contains only image data, the character data may be obtained by OCR, or the like, and converted to PDF, or the like.

Among these, the modified document data 200 may include the modified part when modified by the user. In this case, the modified part is included as metadata, objects, or the like, in the modified document data 200 so that the sentence of the modified part can be identified. Alternatively, data such as a change history may be stored separately in a database for the modified part.

The question sentence 220 is the character string data of a question sentence generated by the question generation model from the character string data of the sentence of the modified part in the modified document data 200. A plurality of the question sentences 220 may be generated from a single modified part. The question sentences 220 may be, for example, sentences in natural language. Specifically, if the modified part is a sentence of a law or a rule that has been changed, a numerical value that is changed in a specific period of time, or the like, the question sentence 220 is a sentence of a question that asks about the sentence or the numerical value. For example, the law or the rule may be a sentence or number in some article, specification, policy, note, accounting, standard value, or the like.

The answer 230 is the character string data of the answer sentence of the question answering model to the question sentence 220. The answer 230 may be generated for each combination for the question sentence 220, the modified document data 200, and the plurality of related document data 210. That is, an answer 230 to the question sentence 220 for the modified document data 200 and an answer 230 to the question sentence 220 for each related document data 210 are stored, respectively. Furthermore, if there is more than one question sentence 220, plurality of answers 230 to these are also stored.

Here, the control unit 10 of the server 1 is made to function as the modified document acquiring unit 100, the related document acquiring unit 110, the question generating unit 120, and the modification deciding unit 130 by executing the control program mainly stored in the storage unit 19.

Further, the units of the server 1 as described above are hardware resources that execute the document management method according to the present disclosure.

In addition, some or any combination of the functional configurations as described above may be configured hardware or circuitry with ICs, programmable logic, FPGA (Field-Programmable Gate Array), or the like.

[Related Document modification and Presentation Process by Server 1]

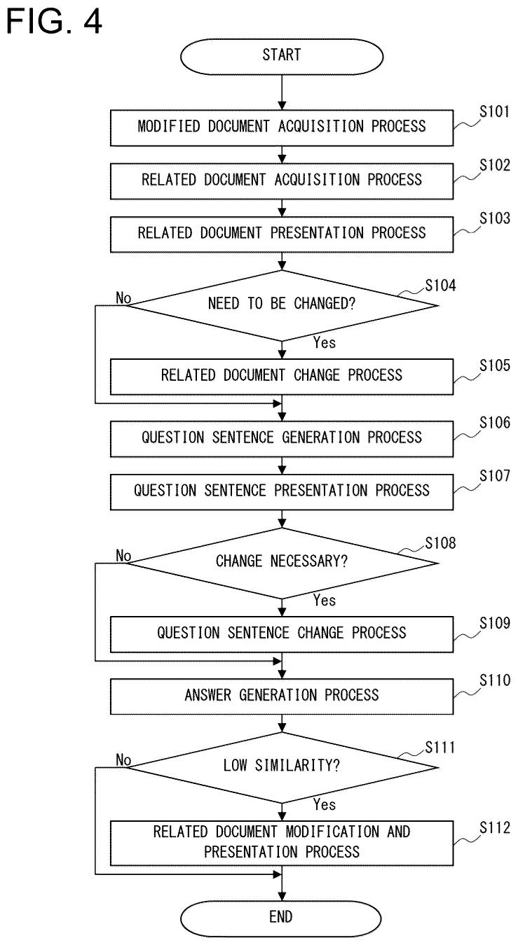

Next, with reference to FIGS. 4 to 6, a related document modification and presentation process by the image forming system X according to the embodiment of the present disclosure is explained.

In the related document modification and presentation process according to the present embodiment, the modified document data 200 modified by the user is acquired. Then, the related document data 210 of the modified document data 200 is selected and acquired from a plurality of document data. Further, a question sentence 220 is generated from the sentence of the modified part in the modified document data 200. On this basis, the answers 230 to the generated question sentences 220 are generated for the modified document data 200 and the related document data 210, respectively. Then, if the similarity between the answers 230 is lower than the specific threshold, it is determined that the related document data 210 needs to be modified. This determination and the related document data 210 that needs to be modified are presented to the user.

In the related document modification and presentation process according to the present embodiment, the control unit 10 of the server 1 mainly executes the program stored in the storage unit 19 in cooperation with the various units by using hardware resources.

In the following, with reference to the flowchart in FIG. 4, the details of the related document modification and presentation process are explained step by step.

### (Step S101)

Firstly, the modified document acquiring unit 100 performs a modified document acquisition process.

Here, a user logs-in the server 1 from the terminal 3 or the image forming apparatus 2 by using the web browser or the dedicated application and uploads a document data from the UI to server 1. Alternatively, the user may scan the document data from the image forming apparatus 2 and upload it to the server 1. The document data are stored in the document management DB 190.

Then, the user can then edit and modify the document data in the document management DB 190. This editing and modification may be done via the UI, or a new file with the same name may be uploaded from the terminal 3 or the image forming apparatus 2.

The modified document acquiring unit 100 acquires this document data that is performed modification as the modified document data 200.

### (Step S102)

Then, the related document acquiring unit 110 performs a related document acquisition process.

The related document acquiring unit 110 selects and acquires the related document data 210 of the modified document data 200 from the plurality of document data in the document management DB 190.

Here, the related document acquiring unit 110 calculates the similarity between the document data. Specifically, when using similarity of the text, the related document acquiring unit 110 inputs the text data of the modified document data 200 and the text data of each document data in the document management DB 190 into a classification model that performs clustering or machine learning. Then, the classification model outputs the similarity between each text data, and it performs clustering, and the like. This allows the related document acquiring unit 110 to select related document data 210 based on the similarity of the text with the modified document data 200.

Alternatively, when using the similarity of the document attributes, the related document acquiring unit 110 inputs the document attributes of the modified document data 200 and the document attributes of each document data in the document management DB 190 into a classification model that performs clustering or machine learning. The related document acquiring unit 110 can acquire the creator, editor, creation time, change time, and viewer as these document attributes from the file attributes and metadata of the document data. The classification model then outputs the similarity of the document attributes, and it performs clustering, and the like. In addition, this classification model of similarity of the document attributes may be a separate model from the classification model of similarity of the text, or it can be a single model with combined inputs.

As a result of these, the related document acquiring unit 110 determines the similarity of the text and/or the similarity of the document attributes.

### (Step S103)

Then, the related document acquiring unit 110 performs a related document presentation process.

The related document acquiring unit 110 presents the selected related document data 210 to the user at the terminal 3 or the image forming apparatus 2. This allows the user to check the related documents.

The user can indicate whether the selected related document data 210 needs to be changed or not via the UI.

### (Step S104)

Then, the related document acquiring unit 110 determines whether or not the related document data 210 needs to be changed. The related document acquiring unit 110 determines Yes if the user indicates that the selected related document data 210 needs to be changed. The related document acquiring unit 110 otherwise determines No, that is, a case that there is no need to change the related document.

If Yes, the related document acquiring unit 110 proceeds to step S105.

If No, the related document acquiring unit 110 proceeds to step S106.

### (Step S105)

If the related document data 210 needs to be changed, the related document acquiring unit 110 performs a related document change process.

The related document acquiring unit 110 changes the related document data 210 of the modified document data 200 to the one specified by the user and registers it in the document management DB 190.

### (Step S106)

Here, the question generating unit 120 performs a question sentence generation process.

The question generating unit 120 generates the question sentence 220 from the sentences of the modified part of the modified document data 200.

The question generating unit 120 automatically generates questions based on the modified part. In the present embodiment, the question generating unit 120 inputs the text data of the modified part into a question generation model such as GAN, or the like. The question generation model then outputs the question sentence 220 in the natural language.

In more detail is explained, the question generating unit 120 generates a plurality of question sentences 220 from the sentence in the modified part by using the question generation model.

Here, it is explained that an example case where the sentence in the modified part has been “In Japan, copyright is valid for 50 years after the author's death” before the modification, and it becomes “In Japan, copyright is valid for 70 years after the author's death (since 2018)” after the modification. In this case, the question generating unit 120 generates a plurality of question sentences 220, for example, “In Japan, how many years after the author's death is copyright valid?”, “In Japan, when did copyright become valid for 70 years after death?”, or the like.

### (Step S107)

Then, the question generating unit 120 performs a question sentence presentation process.

The question generating unit 120 presents the question sentence 220 to the user at the terminal 3 or the image forming apparatus 2. This allows the user to confirm the automatically generated question sentence 220.

The user can indicate in the UI whether the selected question sentence 220 needs to be changed or not.

### (Step S108)

Then, the question generating unit 120 determines whether or not a change is necessary. The question generating unit 120 determines Yes if the user indicates that the question sentence 220 needs to be changed. The question generating unit 120 otherwise determines No, that is, there is no need to be changed. If Yes, the question generating unit 120 proceeds to step S109. If No, the question generating unit 120 proceeds to step S110.

### (Step S109)

If the question sentence 220 needs to be changed, the question generating unit 120 performs a question sentence change process.

The user can change the question to an appropriate question via the UI. This changed question can be registered in the question generation model as training data.

### (Step S110)

Here, the modification deciding unit 130 performs an answer generation process.

The modification deciding unit 130 generates the answer 230 to the question sentences 220 for the modified document data 200 and the answer 230 to the question sentences 220 for the related document data 210, respectively. In the present embodiment, the modification deciding unit 130 inputs the text data of the modified document data 200 and the question sentence 220 into a question answering model such as a transformer. The question answering model then outputs the answer 230 in the natural language. Similarly, the modification deciding unit 130 inputs the text data of each related document data 210 to the question answering model to obtain the answer 230. This process is performed for plurality of question sentence 220.

Then, the modification deciding unit 130 calculates the similarity between the answers 230, which are the pair of the answer 230 to the modified document data 200 and the answer 230 to the related document data 210, respectively. The modification deciding unit 130 may perform the calculation of the similarity whether or not the answers 230 are the same. Alternatively, the modification deciding unit 130 can calculate the similarity between the answers 230 including semantic interpretation of words and sentences. Thus, by checking the similarity between the answers 230 in the question answering model, it is possible to infer whether or not modification is necessary.

For example, for the above question sentence 220, “In Japan, how many years after the author's death is copyright valid?”, the answer 230 to the modified document data 200 is “70”. In contrast, if the answer 230 to “Document A,” which is a related document data 210, is “50,” the modification deciding unit 130 can determine that the similarity between the answers 230 is low because the answers 230 are different. On the other hand, if the answer 230 to “Document B,” which is another related document data 210, is “70,” the modification deciding unit 130 can determine that the similarity is high.

Furthermore, for another question sentence 220, “In Japan, when did copyright become valid for 70 years after death?”, the answer 230 to the modified document data 200 is “2018”. In contrast, if the answer 230 to “Document A” is “N/A,” the modification deciding unit 130 can determine that the similarity between the answers 230 is low. On the other hand, if the answer 230 to “Document B” is “2018,” the modification deciding unit 130 can determine that the similarity is high.

### (Step S111)

Then, the modification deciding unit 130 determines whether the similarity is low or not. If the similarity between the answer 230 of the modified document data 200 to the question sentence 220 and the answer 230 of the related document data 210 to the question sentence 220 is lower than the specific threshold, the modification deciding unit 130 determines that the related document data 210 needs to be modified and determines to be Yes. This specific threshold can be set and adjusted as appropriate from exactly the same to similar semantic information according to the user's setting or the question answering model. The modification deciding unit 130 otherwise determines to be No, that is a case where the similarity is equal to or higher than the specific threshold.

If Yes, the modification deciding unit 130 proceeds to step S112.

If No, the modification deciding unit 130 terminates the related document modification and presentation process.

### (Step S112)

If the similarity is low, the modification deciding unit 130 performs a related document modification and presentation process.

The modification deciding unit 130 indicates to the user that the modification is necessary, the related document data 210 that has been determined to require the modification, and the part that needs to be modified.

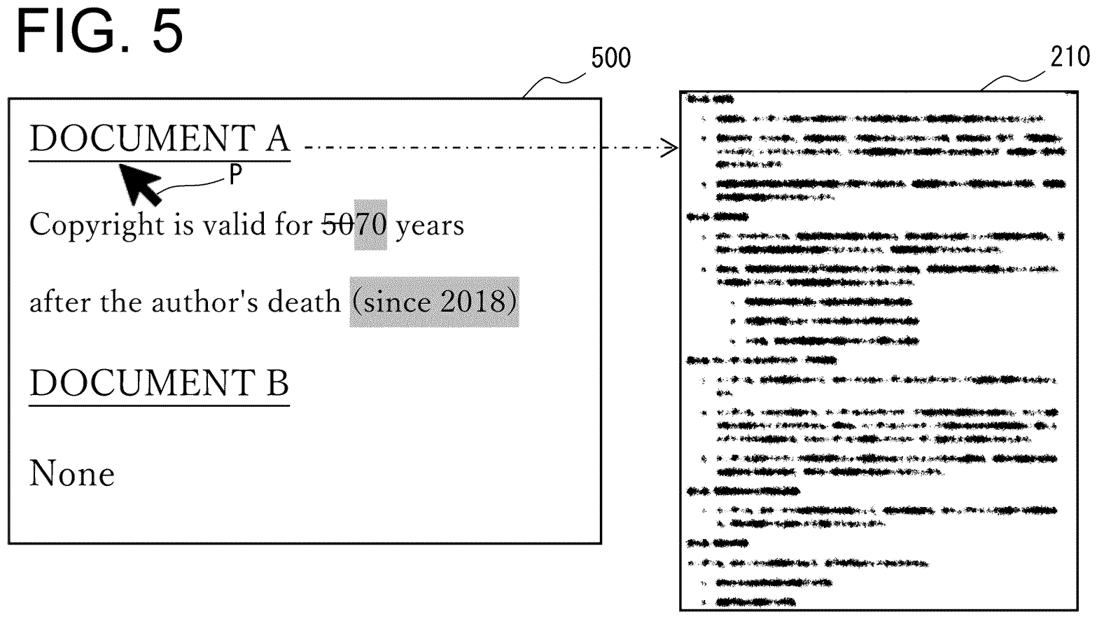

FIG. 5 shows a screen example 500, which is an example of the UI presented for selecting and modifying this related document. In the screen example 500, a plurality of the related document data 210 is presented. In the above example, “Document A” and “Document B” are presented. Here, the modification deciding unit 130 detects that the user presses the link of “Document A” with the pointer P of a pointing device such as a mouse. The modification deciding unit 130 presents the actual related document data 210 of “Document A”. This allows the user to view, edit, and modify the related document data 210 on the UI.

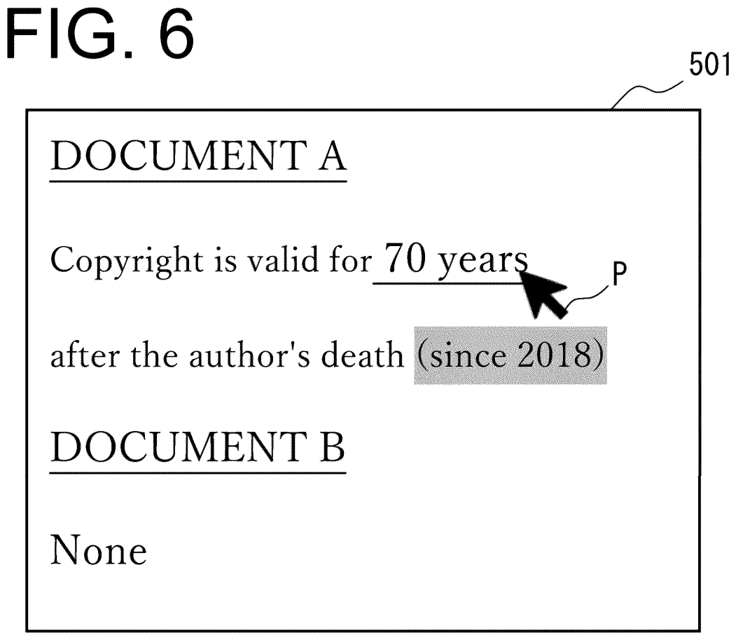

FIG. 6 shows a screen example 501, which is an example of the UI for one-click modification. In the screen example 501, the modification deciding unit 130 detects that the user presses the pointer P on the part of “Document A” that describes “Copyright is valid [50 years] after the author's death.” Thus, the modification deciding unit 130 modifies it to “Copyright is valid for 70 years after the author's death (since 2018).”

In this way, the related document can be easily modified.

This concludes the related document modification and presentation process according to the present disclosure.

As configured in this way, the following effects can be obtained.

In a document management system, when a part of a document is modified, other related documents may also need to be modified. Generally, the related documents are modified by relying on the memory of the user who modified the document, which often results in omissions of modification. In addition, if the modified document is cited in a document unknown to the user who modified it, modification becomes difficult.

In a typical technology detects changes in the similarity of attention sentences between documents and prompts the user to make modifications. In this technology, the user has to manually set the comparison documents and attention sentences. Furthermore, it is time-consuming for the user to check whether the searched documents are really related documents and to actually make modification.

On the other hand, the image forming system X according to an embodiment of the present disclosure is a document management system having a document management server storing a plurality of document data, including: a modified document acquiring unit 100 that acquires modified document data 200 that has been modified; a related document acquiring unit 110 that selects and acquires related document data 210 for the modified document data 200 acquired by the modified document acquiring unit 100 from a plurality of document data; a question generating unit 120 that generates a question sentence 220 from a sentence of a modified part in the modified document data 200 acquired by the modified document acquiring unit 100; and a modification deciding unit 130 that generates answers 230 to the question sentence 220 generated by the question generating unit 120 for the modified document data 200 and the related document data 210, respectively, and, when the similarity between the answers 230 is lower than a specific threshold, determine that the related document data 210 needs to be modified and presents determination to the user.

By configuring the system in this way, the related document data 210 can be automatically suggested to the user without the user having to manually set the related documents. In addition, even if the user does not manually set the focus sentence, the system can automatically generate the question sentence 220 based on the modified part and determine whether modification is necessary by checking the similarity of the answers 230 in the question answering model. In other words, the modified part can be automatically extracted and presented based on the changing in the answers 230 in the question answering model. Thus, it is possible to make an appropriate decision on the modification of the related document data 210. As a result, the user's time and effort for modifying the related document data 210 can be reduced.

Further, in the image forming system X according to the embodiment of the present disclosure, the related document acquiring unit 110 selects the related document data 210 based on similarity of the text with the modified document data 200 and/or selects the related document data 210 based on similarity of document attributes including any of creator, editor, creation time, change time, and viewer with the modified document data 200.

This configuration makes it possible to select the related document data 210 more appropriately without having to manually select it.

Further, in the image forming system X according to the embodiment of the present disclosure, the related document acquiring unit 110 determines the similarity of the text and/or the similarity of the document attributes by a classification model of clustering and/or machine learning.

This configuration makes it possible to select the related document data 210 more appropriately by the classification model.

Further, in the image forming system X according to the embodiment of the present disclosure, the question generating unit 120 presents the question sentence 220 to the user for confirmation.

This configuration allows the user to confirm the automatically generated question sentence 220. In other words, even if an appropriate question is not generated, the user can check it and make it more appropriate. Thus, as a result, the user's load can be reduced. In addition, by feeding back and training from this user's question, the possibility of generating an appropriate question sentence 220 can be increased.

Further, in the image forming system X according to the embodiment of the present disclosure, the question generating unit 120 generates a question sentence by a question generation model of GAN, and the modification deciding unit 130 generates an answer 230 to the question sentence by a question answering model of transformer.

By configuring in this way, the text of the modification is compared by using the question answering model, rather than simply comparing the similarity between the sentence of the modification part and the sentence itself in the related document data 210. As a result, changes can be extracted with lighter processing than full-text similarity comparison. The question answering model of the transformer can also be trained as a GAN discriminator. Thus, the possibility to be selected more appropriate related document data 210 can be increased. In addition, by performing feeding back and training based on the modified documents and their contents, the accuracy of the presentation of modifications can be improved.

### OTHER EMBODIMENTS

In addition, the image forming system X of the embodiment described above describes an example in which server 1 functions as a document management server.

However, a dedicated application may be installed in the image forming apparatus 2 to function as a document management server.

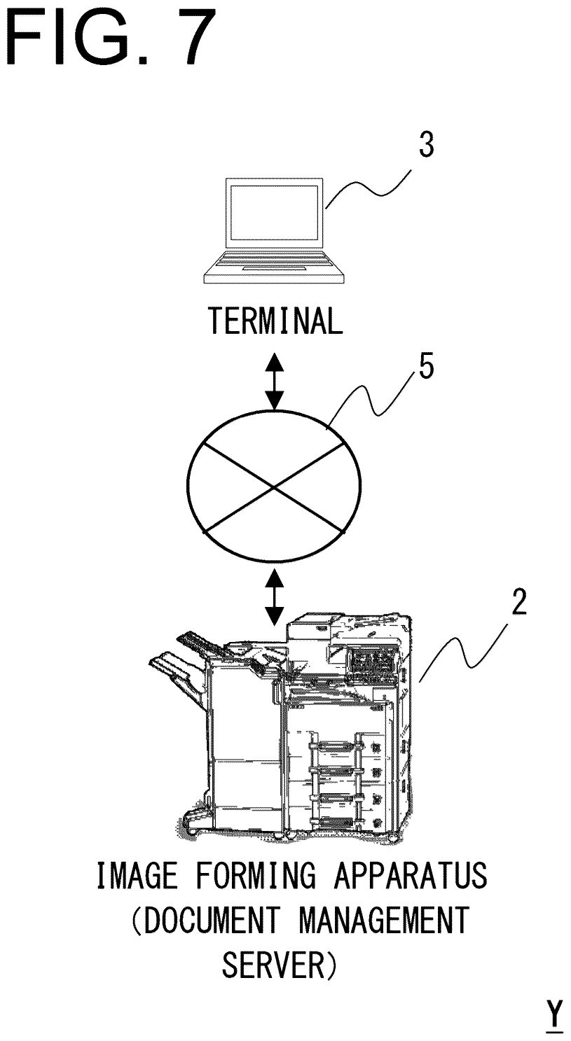

As refer to FIG. 7, a specific example of such an image forming system Y is shown. The image forming apparatus 2 as shown in FIG. 7 may have similar functional configuration as the server 1 as described above.

By configuring in this way, it is possible to automatically present a modification part of a relevant document data simply by installing the dedicated application such that document management is performed in the image forming apparatus.

In addition, the dedicated application, or the like, may be installed in the terminal 3 to function as a document management server in the same manner.

Further, in the embodiment as described above, an example of configuring the question generation model, the question answering model, or the like, locally in the control unit 10 is described.

However, it may also be configured to access an external server provided with a large-scale model for natural language processing, such as GPT-3, GPT-4, or the like, by using an API (Application Programming Interface). In such case, a more appropriate model may be generated in the user's environment by using fine tuning, or the like.

Further, in the embodiments as described above, an example of selecting related document data 210 at the time of uploading the modified document data 200 is described.

However, the related document data 210 may be selected at the time the pre-edited document data is uploaded. In this case, a table indicating the related document data 210 for each single uploaded document data may be stored in the document management DB 190.

This configuration eliminates the need to select related document data 210 for each generation of modified document data 200 and reduces the processing load.

Alternatively, for each document data stored in the document management DB 190, the related document data 210 may be selected by clustering or classification model in free time.

This enables appropriate selection of the related document data 210 for each document data even if the number or content of documents has changed.

Further, in the embodiments as described above, an example of creating modified document data 200 by modifying a document data and presenting modification of related document data 210 at the same time is described.

However, these processes may be executed, separately.

By configuring in this way, the presentation of the modification of the related document data 210 can be performed when necessary or in free time, allowing the user more flexibility in processing.

Further, in the embodiment described above, an example in which the relationship between the modified document data 200 and the related document data 210 is set by the similarity between the document data is described.

However, the related document data 210 may be selected based on each of the modified parts in the modified document data 200. In other words, it is also possible to dynamically change the related document data 210 based on the modified part. In this case, even document data with low similarity in the entire document can be modified at all if similar modifications are cited. For example, when the technical term phrasing, the policy regarding discriminatory terminology, or the like, is modified, it can be applied to appropriate document data in the document management DB 190.

The present disclosure can also be applied to an information processing apparatus other than an image forming apparatus. In other words, it can be configured to use a network scanner, a server separately connected to a scanner via USB, or the like.

In terms used herein, the singular forms “a,” “an,” and “the” also include the plural forms, unless the context clearly indicates otherwise.

It goes without saying that the configuration and operation of the above embodiments are examples, and it may be changed and implemented as appropriate to the extent not departing from the aim of the present disclosure.

1. A document management system having a document management server storing a plurality of document data, comprising:
a modified document acquiring unit configured to acquire modified document data that has been modified;
a related document acquiring unit configured to select and acquire related document data for the modified document data acquired by the modified document acquiring unit from the plurality of document data;
a question generating unit configured to generate a question sentence from a sentence of a modified part in the modified document data acquired by the modified document acquiring unit; and
a modification deciding unit configured to respectively generate answers to the question sentence generated by the question generating unit for the modified document data and the related document data and, when the similarity between the answers is lower than a specific threshold, determine that the related document data needs to be modified and presents the determination to a user;
wherein the related document acquiring unit is configured to:
present the selected related document data to the user;
allow the user to indicate whether the selected related document data needs to be changed via a user interface;
determine whether the selected related document data needs to be changed based on the user indication; and
responsive to a determination that the selected related document data needs to be changed, change the selected related document data to related document data specified by the user.

2. The document management system according to claim 1, wherein
the related document acquiring unit selects the related document data based on similarity of text with the modified document data and/or selects the related document data based on similarity of document attributes including any of creator, editor, creation time, change time, and viewer with the modified document data.

3. The document management system according to claim 2, wherein
the related document acquiring unit determines the similarity of the text and/or the similarity of the document attributes by clustering and/or machine learning.

4. The document management system according to claim 1, wherein
the question generating unit presents the question sentence to the user for confirmation.

5. The document management system according to claim 1, wherein
the question generating unit generates the question sentence by a generative adversarial network, and
the modification deciding unit generates the answers to the question sentence by transformer.

6. A document management server storing a plurality of document data, comprising:
a modified document acquiring unit configured to acquire modified document data that has been modified;
a related document acquiring unit configured to select and acquire related document data for the modified document data acquired by the modified document acquiring unit from the plurality of document data;
a question generating unit configured to generate a question sentence from a sentence of a modified part in the modified document data acquired by the modified document acquiring unit; and
a modification deciding unit configured to respectively generate answers to the question sentence generated by the question generating unit for the modified document data and the related document data and, when the similarity between the answers is lower than a specific threshold, determine that the related document data needs to be modified and presents the determination to a user;
wherein the related document acquiring unit is configured to:
present the selected related document data to the user;
allow the user to indicate whether the selected related document data needs to be changed via a user interface;
determine whether the selected related document data needs to be changed based on the user indication; and
responsive to a determination that the selected related document data needs to be changed, change the selected related document data to related document data specified by the user.

7. The document management server according to claim 6, wherein
the related document acquiring unit selects the related document data based on similarity of text with the modified document data and/or selects the related document data based on similarity of document attributes including any of creator, editor, creation time, change time, and viewer with the modified document data.

8. The document management server according to claim 7, wherein
the related document acquiring unit determines the similarity of the text and/or the similarity of the document attributes by clustering and/or machine learning.

9. The document management server according to claim 6, wherein
the question generating unit presents the question sentence to the user for confirmation.

10. The document management server according to claim 6, wherein
the question generating unit generates the question sentence by a generative adversarial network, and
the modification deciding unit generates the answers to the question sentence by transformer.

11. A document management method executed by a document management system having a document management server storing a plurality of document data, comprising the steps of:
acquiring modified document data that has been modified;
acquiring related document data for the modified document data that has been acquired by selecting from the plurality of document data;
presenting the selected related document data to a user;
allowing, via a user interface, the user to indicate whether the selected related document data needs to be changed;
determining whether the selected related document data needs to be changed based on the user indication;
responsive to a determination that the selected related document data needs to be changed, changing the selected related document data to related document data specified by the user;
generating a question sentence from a sentence of a modified part in the acquired modified document data;
generating answers to the generated question sentences for the modified document data and the related document data, respectively;
determining that, when the similarity between the answers is lower than a specific threshold, the related document data needs to be modified; and
presenting the determination to the user that the related document data needs to be modified.

12. The document management method according to claim 11, wherein
selecting the related document data based on similarity of text with the modified document data and/or selects the related document data based on similarity of document attributes including any of creator, editor, creation time, change time, and viewer with the modified document data.

13. The document management method according to claim 12, wherein
determining the similarity of the text and/or the similarity of the document attributes by clustering and/or machine learning.

14. The document management method according to claim 11, wherein
presenting the question sentence to the user for confirmation.

15. The document management method according to claim 11, wherein
generating the question sentence by a generative adversarial network, and
generating the answers to the question sentence by transformer.

16. The document management system according to claim 1, wherein the related document acquiring unit is configured to:
present a plurality of pressable links, each corresponding to respective related document data of a respective document;
detect that that the user presses a pressable link of the plurality of pressable links; and
responsive to the detection that that the user pressed the pressable link, present the related document data corresponding to the pressable link; and
allow the user to modify the related document data corresponding to the pressable link via the user interface.

17. The document management system according to claim 1, wherein the related document acquiring unit is configured to:
present a plurality of pressable links, each corresponding to respective related document data of a respective document;
detect that that the user presses a pressable link of the plurality of pressable links; and
responsive to the detection that that the user pressed the pressable link, automatically change the related document data corresponding to the pressable link via the user interface with respect to a part that needs to be modified.

18. The document management server according to claim 6, wherein the related document acquiring unit is configured to:
present a plurality of pressable links, each corresponding to respective related document data of a respective document;
detect that that the user presses a pressable link of the plurality of pressable links; and
responsive to the detection that that the user pressed the pressable link, present the related document data corresponding to the pressable link; and
allow the user to modify the related document data corresponding to the pressable link via the user interface.

19. The document management server according to claim 1, wherein the related document acquiring unit is configured to:
present a plurality of pressable links, each corresponding to respective related document data of a respective document;
detect that that the user presses a pressable link of the plurality of pressable links; and
responsive to the detection that that the user pressed the pressable link, automatically change the related document data corresponding to the pressable link via the user interface with respect to a part that needs to be modified.

20. The document management method according to claim 11,
wherein the step of presenting the selected related document data to a user comprises
presenting a plurality of pressable links, each corresponding to respective related document data of a respective document;
detecting that that the user presses a pressable link of the plurality of pressable links; and
responsive to the detection that that the user pressed the pressable link, presenting the related document data corresponding to the pressable link;
wherein the step of changing the selected related document data to related document data specified by the user comprises
allowing the user to modify the related document data corresponding to the pressable link via the user interface.
